(19) United States
(12) Patent Application Publication
(10) Pub. No.: US 2005/0172917 A1
(43) Pub. Date: Aug. 11, 2005

(54) Cylinder head for an internal combustion engine

(76) Inventors: Jochen Betsch, Waiblingen (DE); Michael Dettenmaier, Winnenden (DE); Dirk Heinrich, Karlsruhe (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/051,055

(22) Filed: Feb. 5, 2005

(30) Foreign Application Priority Data
Feb. 6, 2004 (DE) 10 2004 00 5796.6

(51) Int. Cl. F02F 1/36

(52) U.S. Cl. 123/41.82 R; 123/193.5

(57) ABSTRACT

In a cylinder head for a multi-cylinder internal combustion engine including a cylinder head roof with a coolant space disposed below and an oil space disposed above the cylinder head roof, a number of cylinder head bolt support columns arranged along the side walls of the cylinder head, and a recess formed in each cylinder head section for receiving a spark plug or a fuel injection nozzle, laterally extending reinforcement ribs are provided in the oil space which extend in each cylinder head section between the cylinder head structure surrounding the recess and the cylinder head bolt support columns so as to provide a reinforcement grid for the cylinder head.

### BACKGROUND OF THE INVENTION

The invention resides in a cylinder head for a multi-cylinder internal combustion engine including a cylinder head roof arranged between a coolant space and an oil space disposed above the coolant space wherein the cylinder head is provided with cylinder head bolt passage structures which are arranged around each cylinder section and extend through the oil space and with reinforcement ribs which extend in the oil space and of which in each cylinder section at least one reinforcement rib extends from a structure surrounding a recess provided in each cylinder head section for the reception of a spark plug or a fuel injection nozzle.

DE 35 13 126 C2 discloses a cylinder head of this type for an internal combustion engine.. In this cylinder head, the wall structures surrounding individual access holes for the reception of the spark plugs or injection nozzles are connected to the bearing sockets of the camshafts by two reinforcement ribs disposed in the oil space and extending in the longitudinal direction of the cylinder head.

Such a reinforcement structure however is effective mainly in the central area of each cylinder section.

Furthermore, DE 196 00 448 C1 discloses a cylinder head for an internal combustion engine which includes in the coolant space reinforcement ribs which interconnect the cylinder head bolt passage walls with gas exchange passage walls. In this case, only circumferential areas of the cylinder head are reinforced by the reinforcement ribs.

It is the object of the present invention to provide a cylinder head with a reinforcement structure which is effective over a large area of the cylinder head with relatively little constructional expenses.

### SUMMARY OF THE INVENTION

In a cylinder head for a multi-cylinder internal combustion engine including a cylinder head roof with a coolant space disposed below and an oil space disposed above the cylinder head roof, a number of cylinder head bolt support columns arranged along the side walls of the cylinder head, and a recess formed in each cylinder head section for receiving a spark plug or a fuel injection nozzle, laterally extending reinforcement ribs are provided in the oil space which extend in each cylinder head section between the cylinder head structure surrounding the recess and the cylinder head bolt support columns so as to provide a reinforcement grid for the cylinder head.

With the interconnection of these building components by means of the reinforcement ribs, a compound arrangement is provided by which the complete area of the cylinder head roof is reinforced which again increases the rigidity of the whole cylinder head. With the positioning of only relatively small ribs in the cylinder head coolant space and the larger reinforcement ribs in the oil space, the coolant flow in the cylinder head coolant space is not detrimentally affected.

Below an embodiment of the invention will be described in detail with reference to the accompanying drawings.

### BRIEF DESCRIPTION OF THE DRAWINGS

FIG. 1 is a horizontal cross-sectional view of a part of a cylinder head according to the invention taken along line I-I of FIG. 2, and

FIG. 2 is a cross-sectional view of the cylinder head of FIG. 1 in an inclined orientation as installed in a vehicle, the section being taken along line II-II of FIG. 1.

### DESCRIPTION OF A PREFERRED EMBODIMENT

A cylinder head 1 of a four-cycle internal combustion engine including several cylinders consists of a single piece casting with a cylinder head bottom 2 and side walls 4, 5 extending upwardly up to a support surface 3 for a cylinder head cover and the end walls, of which only the end wall 6 is visible. The cylinder head bottom 2 comprises, together with the housing walls 4, 5 and 6, a coolant space 7, which extends essentially parallel to the cylinder head bottom 2 and in spaced relationship therefrom. Above the cylinder head roof 8, there is an oil space 9 for receiving and supporting at least one camshaft and the gas exchange valves. In addition, lubricating oil leaving the bearings of the camshaft is collected in this oil space and returned to the oil sump.

Gas exchange passages 10, 11 extend from the valve openings 12, 13 in the cylinder head bottom 2 through the coolant space 7 up to the housing side walls 4, 5. Between the gas exchange passages, there is a cavity 14 for receiving a spark plug or a fuel injector which cavity extends from the cylinder head bottom 2 all the way up to the support surface 3. The cavity 14 is arranged centrally within the cylinder section 15 and is marked by a dash-dotted circle which also forms the combustion chamber area of a cylinder of the engine.

For the mounting of the cylinder head to an engine block, for each cylinder section 15 four bolt passage structures 16, 17, 18, and 19 are provided which are arranged along the outside the cylinder section 15 at opposite sides of a longitudinal center line 20 and a transverse cylinder line 21. The bolt passages are disposed all at the same distance from the lines 20 and 21 and extend through the cylinder head 1 from the cylinder head bottom to the plane of the support surface 3 for the cylinder head cover. The bolt passage structures 16-19 form together with the walls of the cavity 14 essential reinforcement elements for the cylinder head bottom 2 and the cylinder head roof 8 and also for the cylinder head 1 generally.

In order to increase the rigidity of the cylinder head 1, in accordance with the invention, reinforcement ribs 22, 23, 24 and 25 are provided which are formed integrally with the cylinder head roof 8 and which project from the roof 8 into the oil space 9. The reinforcement ribs 22 to 25 extend essentially in the longitudinal direction of the cylinder head 1 and interconnect each a bolt passage structure 16 to 19 and the cavity wall structure 14. In this way, the bolt passage structure 16 is connected, by way of the reinforcement rib 22, and the bolt passage structure 17 by way of the reinforcement rib 23 and the bolt hole structures 18 and 19 by way of the reinforcement ribs 24 and, respectively, 25 are connected to the cavity wall structure 14. The reinforcement ribs 22 to 25 act like a bridge structures which provide support for the cylinder head bottom 2 particularly in areas in of the cylinder section 15.

The cavity wall structure 14 is provided itself with rib webs 26 and 27 which also contribute to strengthening the cylinder head construction and which are included in the reinforcing arrangement of the bolt passage walls, reinforcement ribs and cavity walls in that the reinforcement ribs 22 to 25 are also connected to the rib webs 26 and 27. It is also possible however that only some of the bolt passage walls are connected to the cavity wall by way of a reinforcement rib.

With the reinforcement ribs 22-25 projecting into the oil space, there is basically the problem that the lubricating oil may not properly drain out of the oil space. This problem could be solved by appropriate openings in the foot area of the reinforcement ribs 22 to 25 since in this way the oil retained by the reinforcement ribs 22 to 25 could drain through the openings toward a lubricating oil return passage.

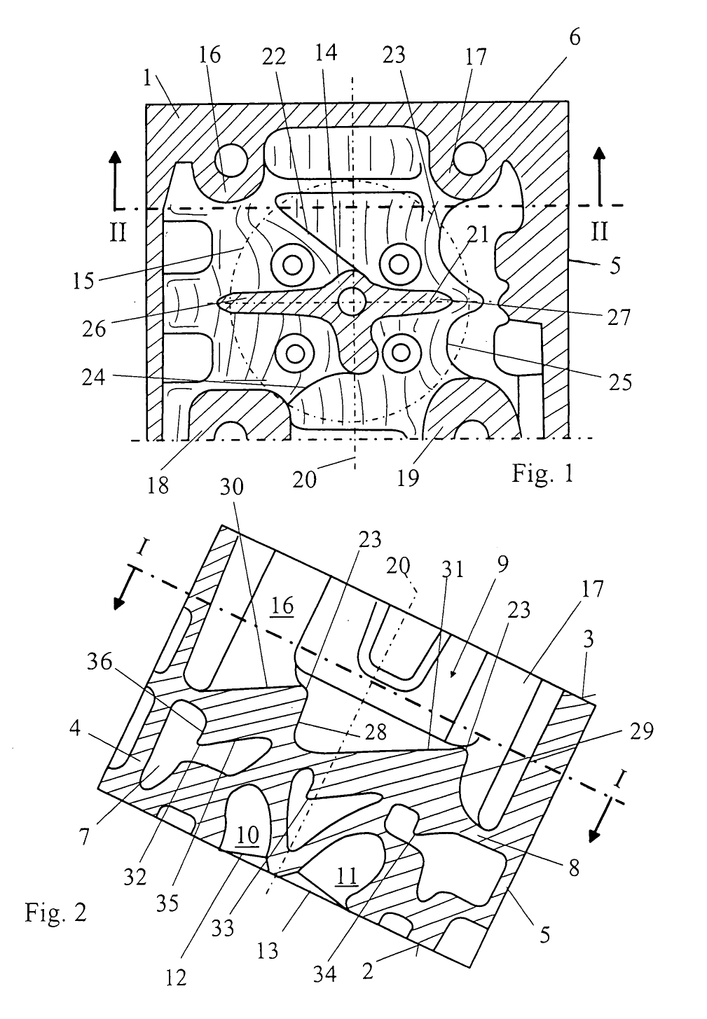

In accordance with the invention, an optimal draining of the lubricating oil from the oil space 9 is achieved by the contour of the reinforcement ribs 22 to 25 being adapted so that, particularly in the inclined installation position of the cylinder head 1 as shown in FIG. 1, the oil can freely drain.

In the inclined installation position of the cylinder head 1, the oil space has a deepest point formed by the corner area between the housing wall 5 and the cylinder head roof 8. From this point, a lubricating oil return passage (not shown) returns the oil to the oil sump.

So that all the oil can reach this deepest point, the reinforcement ribs 22 to 25 have a rib contour which, in cross-section, is similar to a saw-tooth profile as can be seen in the cross-sectional view for the reinforcement ribs 22 and 23. The rib contour is formed by a flank 28, 29, which extends upwardly from the cylinder head roof 8 at a steep angle and which faces toward the housing wall 5, and by a horizontally extending flank which faces the higher housing wall 4. With respect to the installation position, the flanks 28 to 31 therefore form individual steps by way of which the lubricating oil can flow to the lowest point of the oil space in an uninhibited way.

The saw-tooth-like profile of the reinforcement ribs 22-25 has furthermore the advantage that particularly of the horizontal flank 30, 31 larger areas of the cylinder head roof 8 within the various cylinder sections 15 are reinforced providing for a more rigid cylinder head structure.

The increased rigidity of the cylinder head 1 achieved by means of the reinforcement ribs 22-25 is further optimized by the additional reinforcement ribs 32 to 34 in the coolant space 7. The reinforcement ribs 32 to 34 extending from the cylinder head roof 8 also in the longitudinal direction of the cylinder head 1 are disposed opposite the reinforcement ribs 22 to 25 whereby the height of the reinforcement ribs 22 to 25 is increased by the height of the reinforcement ribs 32 to 34 which further increases the rigidity of the cylinder head 1. The reinforcement ribs 32 to 34 have the same profile as the reinforcement ribs 22 to 25 wherein the horizontal flank 35 is disposed below and the steeply inclined flank 36 is disposed at the side facing the housing wall 4 of the reinforcement ribs 32 to 34. As a result, no steam bubbles can form between the reinforcement ribs 32 to 34 and the cylinder head roof 8.

1. A cylinder head (1) for a multi-cylinder internal combustion engine, having cylinder head side walls (5, 6) and cylinder head sections (15), including a coolant space (7), an oil space (9) disposed above the coolant space (7), a cylinder head roof (8) arranged between the coolant space (7) and the oil space (9) and separating the oil space (9) from the coolant space (7), a number of cylinder head bolt support columns (16-19) with bolt guide passages arranged along the cylinder head side walls (5, 6), a recess (14) formed in each cylinder head section (15) for receiving a spark plug or a fuel injection nozzle and reinforcement ribs (22-25) disposed in the oil space (9), at least one reinforcement rib extending in each cylinder head section (15) laterally between the cylinder head area surrounding the recess (14) and the cylinder head bolt support columns (16-19) of the respective cylinder head section (15).

2. A cylinder head for a multi-cylinder internal combustion engine according to claim 1, wherein rib webs (16, 27) extend from the cylinder head area surrounding the recess (14), in a direction transverse to the longitudinal extension of the cylinder head and are joined with the laterally extending reinforcement ribs (22-25).

3. A cylinder head according to claim 1, wherein for an engine wherein, in its installation position, the cylinders are inclined about the longitudinal axis thereof, the reinforcement ribs (22-25) have, in cross-section a saw-tooth profile with one flank (28, 29) raising steeply from the cylinder head roof (8) at one side thereof facing the lower cylinder head side wall (5) of the reinforcement ribs (22-25) and a horizontally extending flank (30, 31) of the reinforcement rib (22-25) facing the higher housing side wall (4).

4. A cylinder head according to claim 3, wherein opposite at least one of the reinforcement ribs (22-25), in the oil space (9), another reinforcement rib (32-34) is provided on the cylinder head roof (8) so as to project into the coolant space (7).

5. A cylinder head according to claim 4, wherein several other reinforcement ribs (32-34) are provided on the cylinder head roof (8) opposite the reinforcement ribs (22-25) and the other reinforcement ribs (32-34) extend in the longitudinal direction of the cylinder head through the coolant space (8).

6. A cylinder head according to claim 5, wherein the other reinforcement ribs (32-34) have the same profile as the reinforcement ribs (22-25) arranged at the opposite side of the cylinder head roof (8) so that their horizontal flanks (35) face downwardly and the steeply inclined flanks (36) each face the upper side wall (4) of the cylinder head.
